(19) United States
(12) Patent Application Publication
(10) Pub. No.: US 2022/0316773 A1
(43) Pub. Date: Oct. 6, 2022

(54) INTEGRATED COOLING SYSTEM

(71) Applicant: Cooler Master Co., Ltd., New Taipei (TW)

(72) Inventors: Wen-Hsien LIN, New Taipei (TW); Teng-Lung LIU, New Taipei (TW)

(21) Appl. No.: 17/395,541

(22) Filed: Aug. 6, 2021

(30) Foreign Application Priority Data
Mar. 31, 2021 (TW) 110203529

(51) Int. Cl. F25B 41/31; F25B 13/00

(52) U.S. Cl. CPC F25B 41/31; F25B 13/00

(57) ABSTRACT

An integrated cooling system including heat exchanger and refrigeration system. Heat exchanger has cold fluid inlet, cold fluid outlet, hot fluid inlet and hot fluid outlet. Refrigeration system includes first thermal expansion valve, first manifold, second thermal expansion valve, air-cooling unit, second manifold, compressor and heat dissipation assembly. First thermal expansion valve is in fluid communication with cold fluid inlet. First manifold includes first to third pipe part. The second thermal expansion valve is in fluid communication with second pipe part. Air-cooling unit is in fluid communication with second thermal expansion valve. Second manifold has fourth to sixth pipe part. Fourth pipe part is in fluid communication with air-cooling unit. Fifth pipe part is in fluid communication with cold fluid outlet. Compressor is in fluid communication with sixth pipe part. Heat dissipation assembly is in fluid communication between compressor and third pipe part.

### CROSS-REFERENCE TO RELATED APPLICATIONS

This non-provisional application claims priority under 35 U.S.C. § 119(a) on Patent Application No(s). 110203529 filed in Taiwan, R.O.C. on Mar. 31, 2021, the entire contents of which are hereby incorporated by reference.

### TECHNICAL FIELD

The disclosure relates to a cooling system, more particularly to an integrated cooling system.

### BACKGROUND

The improvement of computer industry plays an important role in the rapid development of the technology. To enhance the performance of a computer, new motherboard and electronic components (e.g., a central processing unit, graphic processing unit, sound card, and memory) disposed thereon have been developed. For example, the central processing unit has been developed into a multi-core processor nowadays.

Although new electronic component has been enhanced, there is still a large amount of heat generated by the electronic component during the operation thereof. Such heat may increase the ambient temperature of the electronic component, thereby reducing the performance of the electronic component. When the temperature of the electronic component exceeds a threshold, the electronic component may be damaged and thus cause the computer including that electronic component to be crashed.

To solve the problem caused by the heat generated by the electronic component, a cooling system is usually installed on the electronic component or the motherboard. In general, the cooling systems may be categorized into air-cooling system and liquid-cooling system. However, each of the air-cooling system and liquid-cooling system are unable to suit the cooling requirements of the new electronic component. Thus, how to develop a cooling system suiting the cooling requirements of the new electronic component has become a topic issue in this field.

### SUMMARY

The disclosure provides an integrated cooling system that suits the cooling requirements of the electronic component generating a large amount of heat.

One embodiment of this disclosure provides an integrated cooling system including a heat exchanger, and a refrigeration system. The heat exchanger has a cold fluid inlet, a cold fluid outlet, a hot fluid inlet and a hot fluid outlet. The cold fluid inlet is in fluid communication with the cold fluid outlet. The hot fluid inlet is in fluid communication with the hot fluid outlet and is not in fluid communication with the cold fluid inlet and the cold fluid outlet. The refrigeration system includes a first thermal expansion valve, a first manifold, a second thermal expansion valve, an air-cooling unit, a second manifold, a compressor and a heat dissipation assembly. The first thermal expansion valve is in fluid communication with the cold fluid inlet. The first manifold includes a first pipe part, a second pipe part and a third pipe part. The first pipe part is in fluid communication with the first thermal expansion valve. The second pipe part and the third pipe part are in fluid communication with the first pipe part. The second thermal expansion valve is in fluid communication with the second pipe part. The air-cooling unit is in fluid communication with the second thermal expansion valve. The second manifold has a fourth pipe part, a fifth pipe part and a sixth pipe part. The fourth pipe part and the fifth pipe part are in fluid communication with the sixth pipe part. The fourth pipe part is in fluid communication with the air-cooling unit. The fifth pipe part is in fluid communication with the cold fluid outlet. The compressor is in fluid communication with the sixth pipe part. The heat dissipation assembly is in fluid communication between the compressor and the third pipe part of the first manifold.

Another embodiment of this disclosure provides an integrated cooling system including a heat exchanger and a refrigeration system. The heat exchanger has a cold fluid inlet, a cold fluid outlet, a hot fluid inlet and a hot fluid outlet. The cold fluid inlet is in fluid communication with the cold fluid outlet. The hot fluid inlet is in fluid communication with the hot fluid outlet and is not in fluid communication with the cold fluid inlet and the cold fluid outlet. The refrigeration system includes a thermal expansion valve, a heat dissipation assembly and a compressor. The thermal expansion valve is in fluid communication with the cold fluid inlet. The heat dissipation assembly is in fluid communication with the thermal expansion valve. The compressor is in fluid communication between the heat dissipation assembly and the cold fluid outlet.

According to the integrated cooling system disclosed by the above embodiments, the liquid coolant in the water-cooling system is cooled again by the refrigeration system via the heat exchanger, thereby allowing the temperature of the liquid coolant flowing back to the water block to meet the cooling requirement of the heat source generating a large amount of heat, such as an overlocked central processing unit.

Further, in some embodiments, the refrigeration system performs the main cooling cycle and the minor cooling cycle and includes two thermal expansion valves. Thus, the refrigeration system not only can cool the liquid coolant in the water-cooling system via the heat exchanger, but also can selectively cool another component to be cooled (e.g., a chassis or heat source) via the air-cooling unit.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an integrated cooling system according a first embodiment of the disclosure;

FIG. 2 is a perspective view of the integrated cooling system in FIG. 1 according to another viewing angle;

FIG. 3 is a block diagram of the integrated cooling system in FIG. 1;

FIG. 4 is a perspective view of an integrated cooling system according to a second embodiment of the disclosure;

FIG. 5 is a perspective view of the integrated cooling system in FIG. 4 according to another viewing angle;

FIG. 6 is a block diagram of the integrated cooling system in FIG. 4;

FIG. 7 is a perspective view of an integrated cooling system according a third embodiment of the disclosure; and

FIG. 8 is a block diagram of the integrated cooling system in FIG. 7.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

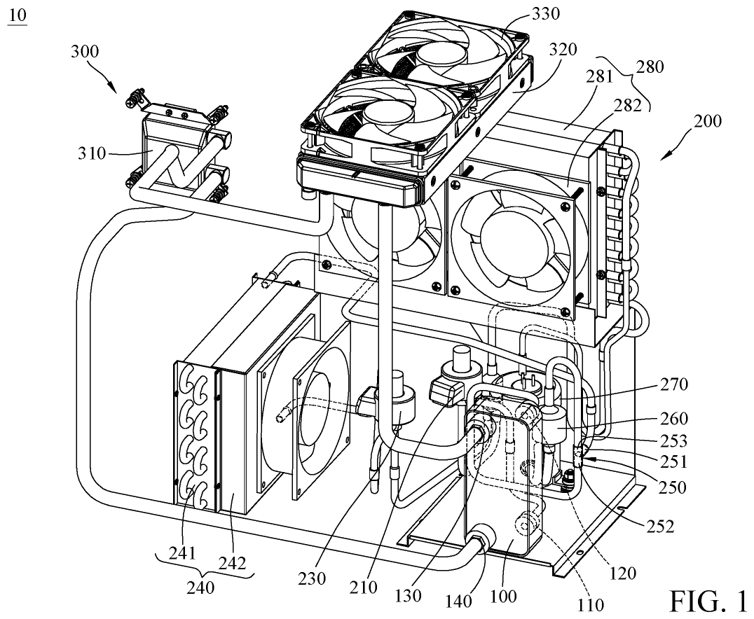

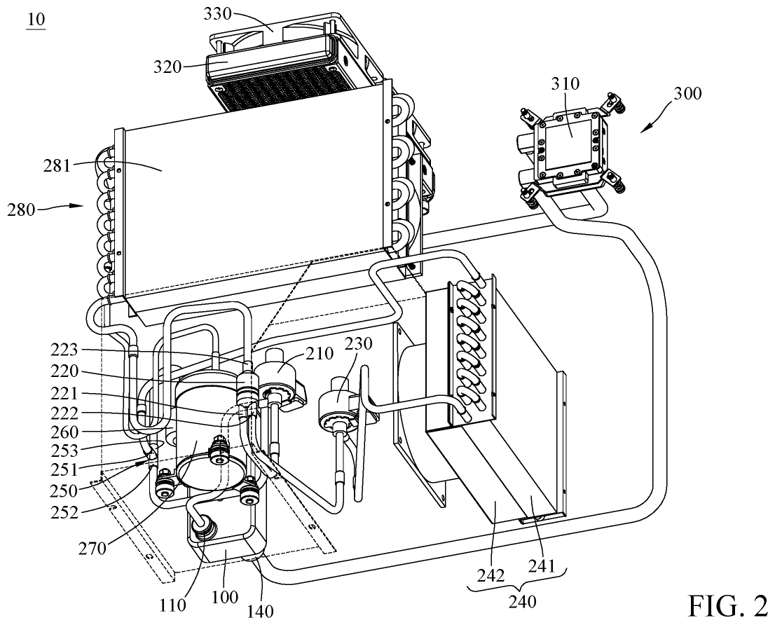

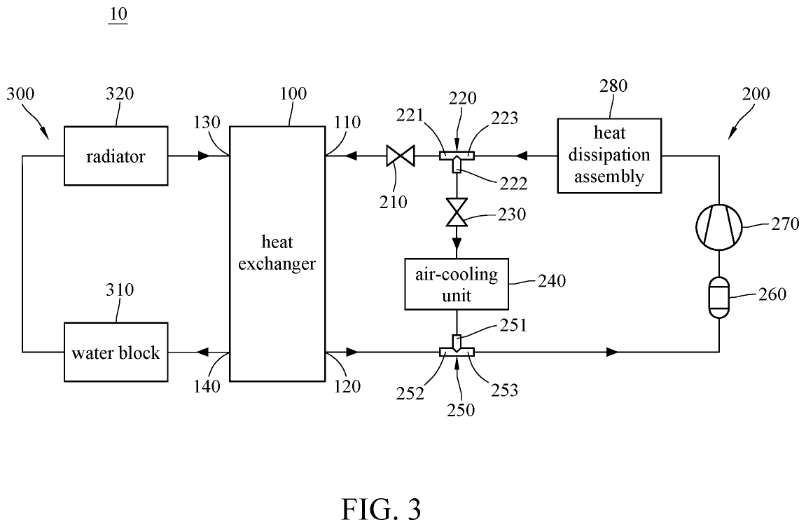

Please refer to FIGS. 1 to 3, where FIG. 1 is a perspective view of an integrated cooling system 10 according a first embodiment of the disclosure, FIG. 2 is a perspective view of the integrated cooling system 10 in FIG. 1 according to another viewing angle, and FIG. 3 is a block diagram of the integrated cooling system 10 in FIG. 1.

In this embodiment, the integrated cooling system 10 includes a heat exchanger 100 and a refrigeration system 200. In addition, the integrated cooling system 10 may further include a water-cooling system 300.

The heat exchanger 100 is, for example, a plate heat exchanger, and is configured to transfer heat. The heat exchanger 100 has a cold fluid inlet 110, a cold fluid outlet 120, a hot fluid inlet 130 and a hot fluid outlet 140. The cold fluid inlet 110 is in fluid communication with the cold fluid outlet 120. The hot fluid inlet 130 is in fluid communication with the hot fluid outlet 140, and is not in fluid communication with the cold fluid inlet 110 and the cold fluid outlet 120.

The refrigeration system 200 includes a first thermal expansion valve 210, a first manifold 220, a second thermal expansion valve 230, an air-cooling unit 240, a second manifold 250, a compressor 270 and a heat dissipation assembly 280. In addition, the refrigeration system 200 may further include a tank 260.

The first thermal expansion valve 210 is in fluid communication with the cold fluid inlet 110 of the heat exchanger 100. The first manifold 220 includes a first pipe part 221, a second pipe part 222 and a third pipe part 223. The first pipe part 221 and the second pipe part 222 are in fluid communication with the third pipe part 223. The first pipe part 221 is in fluid communication with the first thermal expansion valve 210. The second thermal expansion valve 230 is in fluid communication with the second pipe part 222. The air-cooling unit 240 includes, for example, an evaporator 241 and an air-cooling fan 242. The evaporator 241 of the air-cooling unit 240 is, for example, a finned tube evaporator. The evaporator 241 of the air-cooling unit 240 is in fluid communication with the second thermal expansion valve 230. The air-cooling fan 242 is disposed on the evaporator 241, and the air-cooling fan 242 is configured to generate an airflow flowing toward a chassis where the integrated cooling system 10 disposed so as to dissipate the heat accumulated in the chassis.

The second manifold 250 includes a fourth pipe part 251, a fifth pipe part 252 and a sixth pipe part 253. The fourth pipe part 251 and the fifth pipe part 252 are in fluid communication with the sixth pipe part 253. The fourth pipe part 251 is in fluid communication with the air-cooling unit 240. The fifth pipe part 252 is in fluid communication with the cold fluid outlet 120 of the heat exchanger 100.

The tank 260 is, for example, a cylindrical reservoir. The tank 260 is in fluid communication with the sixth pipe part 253 of the second manifold 250. The compressor 270 is in fluid communication with the tank 260.

The heat dissipation assembly 280 includes, for example, a condenser 281 and a heat dissipation fan 282. The condenser 281 of the heat dissipation assembly 280 is in fluid communication between the compressor 270 and the third pipe part 223 of the first manifold 220. The heat dissipation fan 282 is disposed on the condenser 281.

In this embodiment, the tank 260 is additionally disposed to prevent liquid refrigerant in the refrigeration system 200 from flowing back into the compressor 270, but the tank 260 is optional. In other embodiments, the tank 260 may be omitted.

The water-cooling system 300 includes a water block 310 and a radiator 320. In addition, the water-cooling system 300 may further include a water-cooling fan 330.

The water block 310 and the radiator 320 are in serial fluid communication with each other, the water block 310 is in fluid communication with the hot fluid outlet 140 of the heat exchanger 100, and the radiator 320 is in fluid communication with the hot fluid inlet 130 of the heat exchanger 100. That is, the water block 310, the radiator 320 and the heat exchanger 100 are in fluid communication with one another via a piping so as to configure a cooling channel. In this embodiment, the water block 310 includes a built-in pump to drive the liquid coolant to circulate in the cooling channel. The water-cooling fan 330 is disposed on the radiator 320 to dissipate the heat transferred to the radiator 320.

In this embodiment, the water-cooling system 300 dissipates the heat transferred to the liquid coolant via the cooperation of the radiator 320 and the water-cooling fan 330, but the disclosure is not limited thereto. In other embodiments, the water-cooling system may not include the water-cooling fan and may dissipate the heat transferred to the liquid coolant merely via the radiator.

In this embodiment, the water block 310 includes the built-in pump, but the disclosure is not limited thereto. In other embodiments, the water block may not include the built-in pump, and the liquid coolant may be driven by an external pump.

In this embodiment, the water block 310 is configured to be thermally coupled to a heat source (e.g., central processing unit and graphic processing unit) that is overlocked or not overlocked to transfer the heat generated by the heat source to the liquid coolant. Next, the heated liquid coolant that absorbs the heat generated by the heat source flows to the radiator 320 and then to the heat exchanger 100. Thus, the heated liquid coolant is firstly cooled by the radiator 320, and then is cooled again by the cold refrigerant in the refrigeration system 200 (this is described in detail later). The cooled liquid coolant then flows back to the water block 310 to absorb the heat generated by the heat source.

It is noted that the heated liquid coolant is cooled twice to effectively dissipate the heat generated by the heat source that is overlocked or generates a large amount of heat. Taking the overlocked heat source as an example, the heat generated by the overlocked heat source is much more than the heat generated by another heat source that is not overlocked. In a case that the liquid coolant heated by the overlocked heat source is merely cooled by the radiator 320, the temperature of the cooled liquid coolant flowing back to the water block 310 may be too high to meet the cooling requirements of the heat source. However, in this embodiment, since the heated liquid coolant is firstly cooled by the radiator 320 and then is cooled again by the cold refrigerant in the refrigeration system 200, the temperature of the cooled liquid coolant flowing back to the water block 310 can be low enough to meet the cooling requirements of the heat source.

In addition, in this embodiment, the refrigeration system 200 performs a main cooling cycle and a minor cooling cycle. In the main cooling cycle, the compressor 270 drives the gaseous refrigerant and compresses the gaseous refrigerant from low pressure to high pressure and from low temperature to high temperature; the condenser 281 condenses the gaseous refrigerant of high pressure and high temperature into liquid of high pressure and room temperature; the liquid refrigerant of high pressure and room temperature expands in the first thermal expansion valve 210 and thus is transformed into liquid-gas mixture of low pressure and low temperature; the refrigerant that is in the form of liquid-gas mixture of low pressure and low temperature absorbs the heat transferred to the heat exchanger 100 and thus is evaporated into gas of low pressure and low temperature, thereby cooling the liquid coolant of the water-cooling system. In the minor cooling cycle, the compressor 270 drives the gaseous refrigerant and compresses the gaseous refrigerant from low pressure to high pressure and from low temperature to high temperature; the condenser 281 condenses the gaseous refrigerant of high pressure and high temperature into liquid of high pressure and room temperature; the liquid refrigerant of high pressure and room temperature expands in the second thermal expansion valve 230 and thus is transformed into liquid-gas mixture of low pressure and low temperature; the refrigerant that is in the form of liquid-gas mixture of low pressure and low temperature absorbs the heat transferred to the evaporator 241 of the air-cooling unit 240 and thus is evaporated into gas of low pressure and low temperature, thereby cooling another component to be cooled, such as the chassis where the integrated cooling system 10 disposed or another heat source.

With such configuration, with the two thermal expansion valves 210 and 230, the refrigeration system 200 not only can cool the liquid coolant in the water-cooling system 300 via the heat exchanger 100, but also can selectively cool another component to be cooled via the evaporator 241.

The two thermal expansion valves 210 and 230 allow the liquid coolant in the water-cooling system 300 cooled by the radiator 320 of the water-cooling system 300 to be cooled by a refrigerant in the refrigeration system 200 again and allow another component to be cooled to be cooled in the minor cooling cycle.

In this embodiment, the water-cooling fan 330 can be enabled or disabled via a controller (not shown). The controller is, for example, a programmable logic controller (PLC). Also, a direction of an airflow generated by the water-cooling fan 330 can be adjusted by the controller. For example, the controller may enable or disable the water-cooling fan 330 and adjust the direction of the airflow generated by the water-cooling fan 330 based on a temperature value of the liquid coolant detected by a temperature sensor. For the adjustment of the direction of the airflow generated by the water-cooling fan 330, the controller can control the water-cooling fan 330 to blow the airflow out of the electronic device containing the integrated cooling system 10 or blow the airflow into the electronic device. In detail, when the temperature of the liquid coolant in the water-cooling system 300 is high, the controller may control the water-cooling fan 330 to blow the airflow out of the electronic device so as to cool the liquid coolant in the water-cooling system 300. In the contrary, when the temperature of the liquid coolant in the water-cooling system 300 is low, the controller may control the water-cooling fan 330 to blow the airflow into the electronic device so as to cool the electronic device. In addition, a typical pump or a typical compressor generally transfer the liquid coolant or the refrigerant in a single direction, and thus the temperature of the liquid coolant or the refrigerant is unable to be controlled by reversing the transfer direction of the liquid coolant or the refrigerant. Further, in this embodiment, the controller may enable or disable the refrigeration system 200 according to the temperature value of the liquid coolant detected by the temperature sensor.

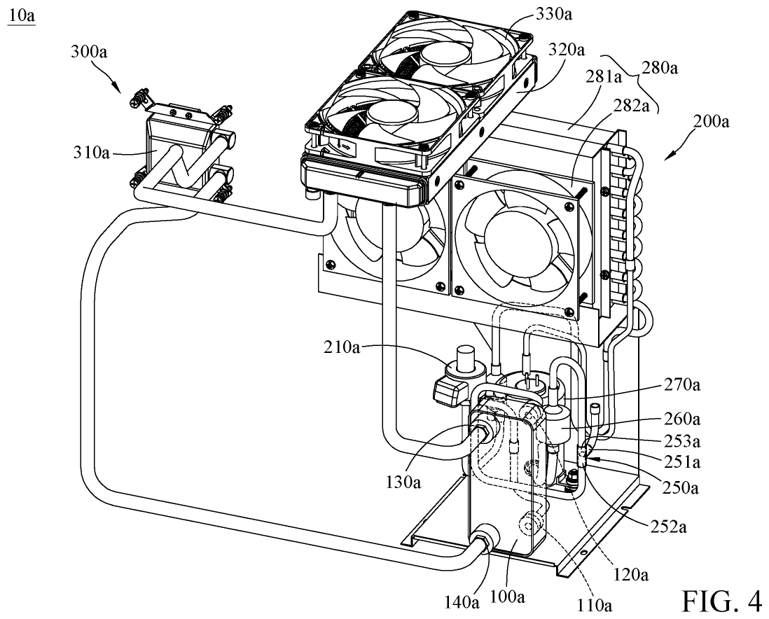

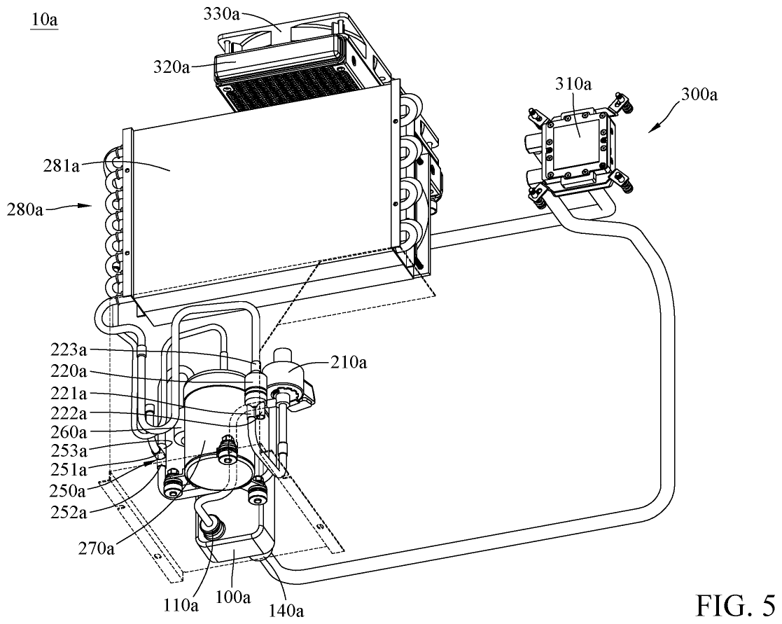

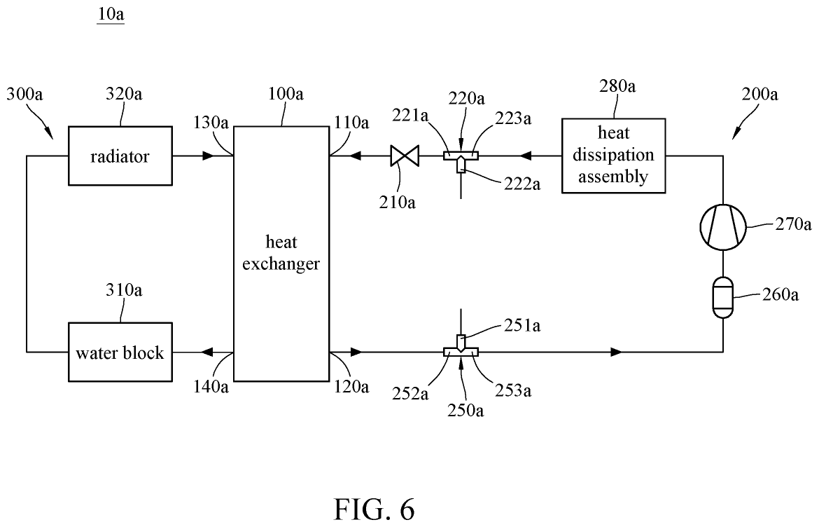

Please refer to FIGS. 4 to 6, where FIG. 4 is a perspective view of an integrated cooling system 10a according to a second embodiment of the disclosure, FIG. 5 is a perspective view of the integrated cooling system 10a in FIG. 4 according to another viewing angle, and FIG. 6 is a block diagram of the integrated cooling system 10a in FIG. 4.

In this embodiment, the integrated cooling system 10a includes a heat exchanger 100a and a refrigeration system 200a. In addition, the integrated cooling system 10a may further include a water-cooling system 300a.

The heat exchanger 100a is, for example, a plate heat exchanger. The heat exchanger 100a has a cold fluid inlet 110a, a cold fluid outlet 120a, a hot fluid inlet 130a and a hot fluid outlet 140a. The cold fluid inlet 110a is in fluid communication with the cold fluid outlet 120a. The hot fluid inlet 130a is in fluid communication with the hot fluid outlet 140a, and is not in fluid communication with the cold fluid inlet 110a and the cold fluid outlet 120a.

The refrigeration system 200a includes a first thermal expansion valve 210a, a compressor 270a and a heat dissipation assembly 280a. In addition, the refrigeration system 200a may further include a first manifold 220a, a second manifold 250a and a tank 260a.

The first thermal expansion valve 210a is in fluid communication with the cold fluid inlet 110a of the heat exchanger 100a. The first manifold 220a includes a first pipe part 221a, a second pipe part 222a and a third pipe part 223a. The first pipe part 221a and the second pipe part 222a are in fluid communication with the third pipe part 223a. The first pipe part 221a is in fluid communication with the first thermal expansion valve 210a. The second manifold 250a includes a fourth pipe part 251a, a fifth pipe part 252a and a sixth pipe part 253a. The fourth pipe part 251a and the fifth pipe part 252a are in fluid communication with the sixth pipe part 253a. The fifth pipe part 252a is in fluid communication with the cold fluid outlet 120a of the heat exchanger 100a.

The tank 260a is, for example, a cylinder reservoir. The tank 260a is in fluid communication with the sixth pipe part 253a of the second manifold 250a. The compressor 270a is in fluid communication with the tank 260a.

The heat dissipation assembly 280a includes, for example, a condenser 281a and a heat dissipation fan 282a. The condenser 281a of the heat dissipation assembly 280a is in fluid communication between the compressor 270a and the third pipe part 223a of the first manifold 220a. The heat dissipation fan 282a is disposed on the condenser 281a.

In this embodiment, the tank 260a is additionally disposed to prevent liquid refrigerant in the refrigeration system 200a from flowing back into the compressor 270a, but the tank 260a is optional. In other embodiments, the tank 260a may be omitted.

In this embodiment, the tank 260a is in fluid communication with the sixth pipe part 253a of the second manifold 250a, and the condenser 281a is in fluid communication with the third pipe part 223a of the first manifold 220a, but the disclosure is not limited thereto. In other embodiments, the tank may be in fluid communication with the fourth pipe part 251a of the second manifold 250a, and the condenser may be in fluid communication with the second pipe part 222a of the first manifold 220a.

In this embodiment, the condenser 281a and the heat exchanger 100a are in fluid communication with each other by the first manifold 220a, and the tank 260a and the heat exchanger 100a are in fluid communication with each other by the second manifold 250a, but the disclosure is not limited thereto. In other embodiments, the condenser 281a and the heat exchanger 100a may be in fluid communication with each other via a straight pipe, and the tank 260a and the heat exchanger 100a may be in fluid communication with each other by a straight pipe.

The water-cooling system 300a includes a water block 310a and a radiator 320a. In addition, the water-cooling system 300a may further include a water-cooling fan 330a.

The water block 310a and the radiator 320a are in serial fluid communication with each other, the water block 310a is in fluid communication with the hot fluid outlet 140a of the heat exchanger 100a, and the radiator 320a is in fluid communication with the hot fluid inlet 130a of the heat exchanger 100a. That is, the water block 310a, the radiator 320a and the heat exchanger 100a are in fluid communication with one another via one or more pipes so as to configured a cooling channel. In this embodiment, the water block 310a includes a built-in pump to drive the liquid coolant to circulate in the cooling channel. The water-cooling fan 330a is disposed on the radiator 320a to dissipate the heat transferred to the radiator 320a.

In this embodiment, the water-cooling system 300a dissipates the heat transferred to the liquid coolant via the cooperation of the radiator 320a and the water-cooling fan 330a, but the disclosure is not limited thereto. In other embodiments, the water-cooling system may not include the water-cooling fan and may dissipate the heat transferred to the liquid coolant merely via the radiator.

In this embodiment, the water block 310a includes the built-in pump, but the disclosure is not limited thereto. In other embodiments, the water block may not include the built-in pump, and the liquid coolant may be driven by an external pump.

In this embodiment, the water block 310a is configured to be thermally coupled to a heat source (e.g., central processing unit and graphic processing unit) that is overlocked or not overlocked to transfer the heat generated by the heat source to the liquid coolant. Next, the heated liquid coolant that absorbs the heat generated by the heat source flows to the radiator 320a and then to the heat exchanger 100a. Thus, the heated liquid coolant is firstly cooled by the radiator 320a, and then is cooled again by the cold refrigerant in the refrigeration system 200a (this is described in detail later). The cooled liquid coolant then flows back to the water block 310a to absorb the heat generated by the heat source.

It is noted that the heated liquid coolant is cooled twice to effectively dissipate the heat generated by the heat source that is overlocked or generates a large amount of heat. Taking the overlocked heat source as an example, the heat generated by the overlocked heat source is much more than the heat generated by another heat source that is not overlocked. In a case that the liquid coolant heated by the overlocked heat source is merely cooled by the radiator 320a, the temperature of the cooled liquid coolant flowing back to the water block 310a may be too high to meet the cooling requirements of the heat source. However, in this embodiment, since the heated liquid coolant is firstly cooled by the radiator 320a and then is cooled again by the cold refrigerant in the refrigeration system 200a, the temperature of the cooled liquid coolant flowing back to the water block 310a can be low enough to meet the cooling requirements of the heat source.

In this embodiment, the water-cooling fan 330a can be enabled or disabled via a controller (not shown). The controller is, for example, a programmable logic controller (PLC). Also, a direction of an airflow generated by the water-cooling fan 330a can be adjusted by the controller. For example, the controller may enable or disable the water-cooling fan 330a and adjust the direction of the airflow generated by the water-cooling fan 330a based on a temperature value of the liquid coolant detected by a temperature sensor. For the adjustment of the direction of the airflow generated by the water-cooling fan 330a, the controller can control the water-cooling fan 330a to blow the airflow out of the electronic device containing the integrated cooling system 10a or blow the airflow into the electronic device. In detail, when the temperature of the liquid coolant in the water-cooling system 300a is high, the controller may control the water-cooling fan 330a to; blow the airflow out of the electronic device so as to cool the liquid coolant in the water-cooling system 300a. In the contrary, when the temperature of the liquid coolant in the water-cooling system 300a is low, the controller may control the water-cooling fan 330a to blow the airflow into the electronic device so as to cool the electronic device.

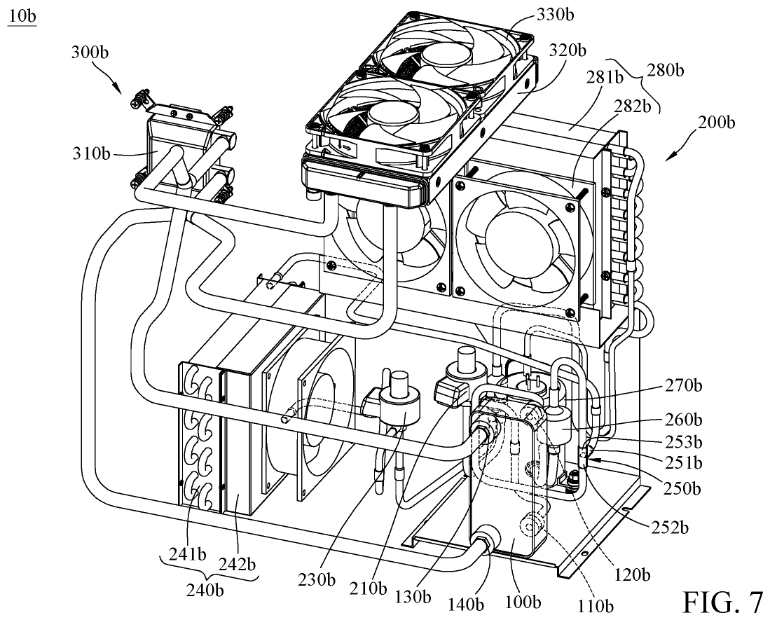

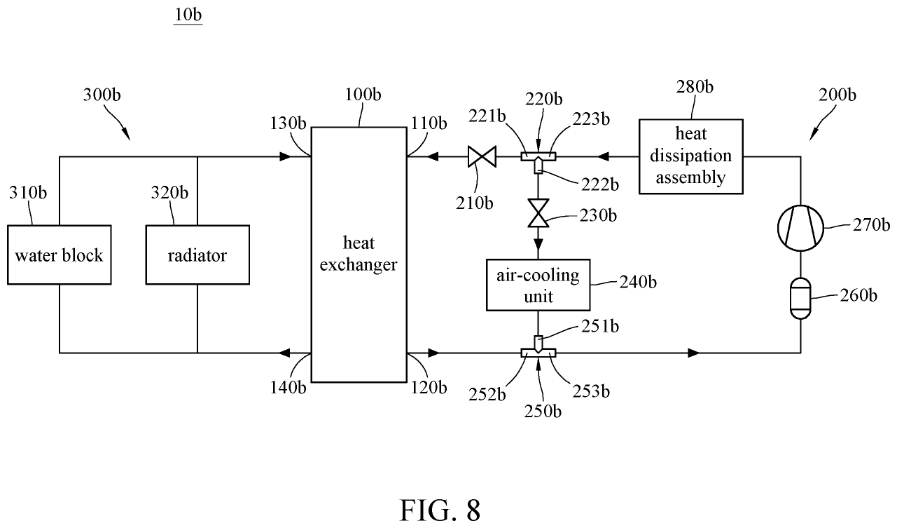

Please refer to FIGS. 7 and 8, where FIG. 7 is a perspective view of an integrated cooling system 10b according a third embodiment of the disclosure, and FIG. 8 is a block diagram of the integrated cooling system 10b in FIG. 7.

In this embodiment, the integrated cooling system 10b includes a heat exchanger 100b and a refrigeration system 200b. In addition, the integrated cooling system 10b may further include a water-cooling system 300b.

The heat exchanger 100b is, for example, a plate heat exchanger, and is configured to transfer heat. The heat exchanger 100b has a cold fluid inlet 110b, a cold fluid outlet 120b, a hot fluid inlet 130b and a hot fluid outlet 140b. The cold fluid inlet 110b is in fluid communication with the cold fluid outlet 120b. The hot fluid inlet 130b is in fluid communication with the hot fluid outlet 140b, and is not in fluid communication with the cold fluid inlet 110b and the cold fluid outlet 120b.

The refrigeration system 200b includes a first thermal expansion valve 210b, a first manifold 220b, a second thermal expansion valve 230b, an air-cooling unit 240b, a second manifold 250b, a compressor 270b and a heat dissipation assembly 280b. In addition, the refrigeration system 200b may further include a tank 260b.

The first thermal expansion valve 210b is in fluid communication with the cold fluid inlet 110b of the heat exchanger 100b. The first manifold 220b includes a first pipe part 221b, a second pipe part 222b and a third pipe part 223b. The first pipe part 221b and the second pipe part 222b are in fluid communication with the second pipe part 222b. The first pipe part 221b is in fluid communication with the first thermal expansion valve 210b. The second thermal expansion valve 230b is in fluid communication with the second pipe part 222b. The air-cooling unit 240b includes, for example, an evaporator 241b and an air-cooling fan 242b. The evaporator 241b of the air-cooling unit 240b is, for example, a finned tube evaporator. The evaporator 241b is in fluid communication with the second thermal expansion valve 230b. The air-cooling fan 242b is disposed on the evaporator 241b, and the air-cooling fan 242b is configured to generate an airflow flowing toward a chassis where the integrated cooling system 10 disposed so as to dissipate the heat accumulated in the chassis.

The second manifold 250b includes a fourth pipe part 251b, a fifth pipe part 252b and a sixth pipe part 253b. The fourth pipe part 251b and the fifth pipe part 252b are in fluid communication with the sixth pipe part 253b. The fifth pipe part 252b is in fluid communication with the cold fluid outlet 120b of the heat exchanger 100b.

The tank 260b is, for example, a cylinder reservoir. The tank 260b is in fluid communication with the sixth pipe part 253b of the second manifold 250b. The compressor 270b is in fluid communication with the tank 260b.

The heat dissipation assembly 280b includes, for example, a condenser 281b and a heat dissipation fan 282b. The condenser 281b of the heat dissipation assembly 280b is in fluid communication between the compressor 270b and the third pipe part 223b of the first manifold 220b. The heat dissipation fan 282b is disposed on the condenser 281b.

In this embodiment, the tank 260b is additionally disposed to prevent liquid refrigerant in the refrigeration system 200b from flowing back into the compressor 270b, but the tank 260b is optional. In other embodiments, the tank 260b may be omitted.

In this embodiment, the tank 260b is in fluid communication with the sixth pipe part 253b of the second manifold 250b, and the condenser 281b is in fluid communication with the third pipe part 223b of the first manifold 220b, but the disclosure is not limited thereto. In other embodiments, the tank may be in fluid communication with the fourth pipe part 251b of the second manifold 250b, and the condenser may be in fluid communication with the second pipe part 222b of the first manifold 220b.

The water-cooling system 300b includes a water block 310b and a radiator 320b. In addition, the water-cooling system 300b may further include a water-cooling fan 330b.

The water block 310b and the radiator 320b are in parallel fluid communication with each other, and two opposite ends of each of the water block 310b and the radiator 320b are in fluid communication with the hot fluid outlet 140b and the hot fluid inlet 130b, respectively. That is, the water block 310b, the radiator 320b and the heat exchanger 100b are in fluid communication with one another via one or more pipes so as to configure a cooling channel. In this embodiment, the water block 310b includes a built-in pump to drive the liquid coolant to circulate in the cooling channel. The water-cooling fan 330b is disposed on the radiator 320b to dissipate the heat transferred to the radiator 320b.

In this embodiment, the water-cooling system 300b dissipates the heat transferred to the liquid coolant via the cooperation of the radiator 320b and the water-cooling fan 330b, but the disclosure is not limited thereto. In other embodiments, the water-cooling system may not include the water-cooling fan and may dissipate the heat transferred to the liquid coolant merely via the radiator.

In this embodiment, the water block 310b includes the built-in pump, but the disclosure is not limited thereto. In other embodiments, the water block may not include the built-in pump, and the liquid coolant may be driven by an external pump.

In this embodiment, the water block 310b is configured to be thermally coupled to a heat source (e.g., central processing unit and graphic processing unit) that is overlocked or not overlocked to transfer the heat generated by the heat source to the liquid coolant. Next, the heated liquid coolant that absorbs the heat generated by the heat source flows to the radiator 320b and then to the heat exchanger 100b. Thus, the heated liquid coolant is firstly cooled by the radiator 320b, and then is cooled again by the cold refrigerant in the refrigeration system 200b (this is described in detail later). The cooled liquid coolant then flows back to the water block 310b to absorb the heat generated by the heat source.

It is noted that the heated liquid coolant is cooled twice to effectively dissipate the heat generated by the heat source that is overlocked or generates a large amount of heat. Taking the overlocked heat source as an example, the heat generated by the overlocked heat source is much more than the heat generated by another heat source that is not overlocked. In a case that the liquid coolant heated by the overlocked heat source is merely cooled by the radiator 320b, the temperature of the cooled liquid coolant flowing back to the water block 310b may be too high to meet the cooling requirements of the heat source. However, in this embodiment, since the heated liquid coolant is firstly cooled by the radiator 320b and then is cooled again by the cold refrigerant in the refrigeration system 200b, the temperature of the cooled liquid coolant flowing back to the water block 310b can be low enough to meet the cooling requirements of the heat source.

In addition, in this embodiment, the refrigeration system 200b performs a main cooling cycle and a minor cooling cycle. In the main cooling cycle, the compressor 270b drives the gaseous refrigerant and compresses the gaseous refrigerant from low pressure to high pressure and from low temperature to high temperature; the condenser 281b condenses the gaseous refrigerant of high pressure and high temperature into liquid of high pressure and room temperature; the liquid refrigerant of high pressure and room temperature expands in the first thermal expansion valve 210b and thus is transformed into liquid-gas mixture of low pressure and low temperature; the refrigerant that is in the form of liquid-gas mixture of low pressure and low temperature absorbs the heat transferred to the heat exchanger 100b and thus is evaporated into gas of low pressure and low temperature, thereby cooling the liquid coolant of the water-cooling system. In the minor cooling cycle, the compressor 270b drives the gaseous refrigerant and compresses the gaseous refrigerant from low pressure to high pressure and from low temperature to high temperature; the condenser 281b condenses the gaseous refrigerant of high pressure and high temperature into liquid of high pressure and room temperature; the liquid refrigerant of high pressure and room temperature expands in the second thermal expansion valve 230b and thus is transformed into liquid-gas mixture of low pressure and low temperature; the refrigerant that is in the form of liquid-gas mixture of low pressure and low temperature absorbs the heat transferred to the evaporator 241b of the air-cooling unit 240b and thus is evaporated into gas of low pressure and low temperature, thereby cooling another component to be cooled, such as the chassis where the integrated cooling system 10b disposed or another heat source.

The two thermal expansion valves 210b and 230b allow the liquid coolant in the water-cooling system 300b cooled by the radiator 320b of the water-cooling system 300b to be cooled by a refrigerant in the refrigeration system 200b again and allow another component to be cooled to be cooled in the minor cooling cycle.

With such configuration, with the two thermal expansion valves 210b and 230b, the refrigeration system 200b not only can cool the liquid coolant in the water-cooling system 300b via the heat exchanger 100b, but also can selectively cool another component to be cooled via the evaporator 241b.

According to the integrated cooling system disclosed by the above embodiments, since the refrigeration system is integrated with another cooling system (e.g., the water-cooling system) via the heat exchanger, the liquid coolant in the water-cooling system is cooled again by the refrigeration system via the heat exchanger, thereby allowing the temperature of the liquid coolant flowing back to the water block to meet the cooling requirement of the heat source generating a large amount of heat, such as an overlocked central processing unit.

Further, in some embodiments, the refrigeration system performs the main cooling cycle and the minor cooling cycle and includes two thermal expansion valves. Thus, the refrigeration system not only can cool the liquid coolant in the water-cooling system via the heat exchanger, but also can selectively cool another component to be cooled (e.g., a chassis or heat source) via the air-cooling unit.

Moreover, in some embodiments, the water block and the radiator are in serial fluid communication with each other. Thus, the controller may enable or disable the water-cooling fan and adjust the direction of the airflow generated by the water-cooling fan based on the temperature of the liquid coolant, thereby enhancing the heat dissipation efficiency of the water-cooling system.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An integrated cooling system, comprising:
a heat exchanger, having a cold fluid inlet, a cold fluid outlet, a hot fluid inlet and a hot fluid outlet, wherein the cold fluid inlet is in fluid communication with the cold fluid outlet, the hot fluid inlet is in fluid communication with the hot fluid outlet and is not in fluid communication with the cold fluid inlet and the cold fluid outlet; and
a refrigeration system, comprising:
a first thermal expansion valve, in fluid communication with the cold fluid inlet;
a first manifold, comprising a first pipe part, a second pipe part and a third pipe part, wherein the first pipe part is in fluid communication with the first thermal expansion valve, the second pipe part and the third pipe part are in fluid communication with the first pipe part;
a second thermal expansion valve, in fluid communication with the second pipe part;
an air-cooling unit, in fluid communication with the second thermal expansion valve;
a second manifold, having a fourth pipe part, a fifth pipe part and a sixth pipe part, wherein the fourth pipe part and the fifth pipe part are in fluid communication with the sixth pipe part, the fourth pipe part is in fluid communication with the air-cooling unit, the fifth pipe part is in fluid communication with the cold fluid outlet;
a compressor, in fluid communication with the sixth pipe part; and
a heat dissipation assembly, in fluid communication between the compressor and the third pipe part of the first manifold.

2. The integrated cooling system according to claim 1, wherein the refrigeration system further comprises a tank, the tank is in fluid communication between the compressor and the sixth pipe part of the second manifold.

3. The integrated cooling system according to claim 1, wherein the air-cooling unit comprises an evaporator and an air-cooling fan, the evaporator is in fluid communication with the second thermal expansion valve, the air-cooling fan is disposed on the evaporator.

4. The integrated cooling system according to claim 1, wherein the heat dissipation assembly comprises a condenser and a heat dissipation fan, the condenser is in fluid communication between the compressor and the third pipe part of the first manifold, the heat dissipation fan is disposed on the condenser.

5. The integrated cooling system according to claim 1, further comprising a water-cooling system, wherein the water-cooling system comprises a water block and a radiator, the water block and the radiator are in serial fluid communication with each other, the water block is in fluid communication with the hot fluid outlet, the radiator is in fluid communication with the hot fluid inlet.

6. The integrated cooling system according to claim 5, wherein the water-cooling system further comprises a water-cooling fan disposed on the radiator.

7. The integrated cooling system according to claim 1, further comprising a water-cooling system, wherein the water-cooling system comprises a water block and a radiator, the water block and the radiator are in parallel fluid communication with each other, and two opposite ends of each of the water block and the radiator are in fluid communication with the hot fluid outlet and the hot fluid inlet, respectively.

8. The integrated cooling system according to claim 7, wherein the water-cooling system further comprises a water-cooling fan disposed on the radiator.

9. An integrated cooling system, comprising:
a heat exchanger, having a cold fluid inlet, a cold fluid outlet, a hot fluid inlet and a hot fluid outlet, wherein the cold fluid inlet is in fluid communication with the cold fluid outlet, the hot fluid inlet is in fluid communication with the hot fluid outlet and is not in fluid communication with the cold fluid inlet and the cold fluid outlet; and
a refrigeration system, comprising:
a thermal expansion valve, in fluid communication with the cold fluid inlet;
a heat dissipation assembly, in fluid communication with the thermal expansion valve; and
a compressor, in fluid communication between the heat dissipation assembly and the cold fluid outlet.

10. The integrated cooling system according to claim 9, wherein the refrigeration system further comprises a first manifold and a second manifold, the first manifold comprises a first pipe part, a second pipe part and a third pipe part, the first pipe part is in fluid communication with the thermal expansion valve, the second pipe part and the third pipe part are in fluid communication with the first pipe part, the heat dissipation assembly is in fluid communication with the second pipe part or the third pipe part, the second manifold comprises a fourth pipe part, a fifth pipe part and a sixth pipe part, the fourth pipe part and the fifth pipe part are in fluid communication with the sixth pipe part, the fourth pipe part or the fifth pipe part is in fluid communication with the cold fluid outlet, the sixth pipe part is in fluid communication with the compressor.

11. The integrated cooling system according to claim 10, wherein the refrigeration system further comprises a tank, the tank is in fluid communication between the compressor and the sixth pipe part of the second manifold.

12. The integrated cooling system according to claim 9, wherein the heat dissipation assembly comprises a condenser and a heat dissipation fan, the condenser is in fluid communication between the compressor and the thermal expansion valve, the heat dissipation fan is disposed on the condenser.

13. The integrated cooling system according to claim 9, further comprising a water-cooling system, wherein the water-cooling system comprises a water block and a radiator, the water block and the radiator are in serial fluid communication with each other, the water block is in fluid communication with the hot fluid outlet, the radiator is in fluid communication with the hot fluid inlet.

14. The integrated cooling system according to claim 13, wherein the water-cooling system further comprises a water-cooling fan disposed on the radiator.

15. The integrated cooling system according to claim 9, further comprising a water-cooling system, wherein the water-cooling system comprises a water block and a radiator, the water block and the radiator are in parallel fluid communication with each other, and two opposite ends of each of the water block and the radiator are in fluid communication with the hot fluid outlet and the hot fluid inlet, respectively.

16. The integrated cooling system according to claim 15, wherein the water-cooling system further comprising a water-cooling fan disposed on the radiator.

17. An integrated cooling system, comprising:
a heat exchanger, configured to transfer heat; and
a refrigeration system, in fluid communication with the heat exchanger and performing a main cooling cycle and a minor cooling cycle, the refrigeration system comprising:
at least one thermal expansion valve, allowing a liquid coolant in a water-cooling system cooled by a radiator of the water-cooling system to be cooled by a refrigerant in the refrigeration system again and allowing another component to be cooled to be cooled in the minor cooling cycle.

18. The integrated cooling system according to claim 17, wherein:
the heat exchanger has a cold fluid inlet, a cold fluid outlet, a hot fluid inlet and a hot fluid outlet, the cold fluid inlet is in fluid communication with the cold fluid outlet, the hot fluid inlet is in fluid communication with the hot fluid outlet and is not in fluid communication with the cold fluid inlet and the cold fluid outlet; and
the refrigeration system comprises:
a compressor, in fluid communication with the cold fluid outlet and configured to drive the refrigerant and compress the refrigerant into gas of high pressure and high temperature;
a heat dissipation assembly, in fluid communication with the compressor and configured to condense the refrigerant that is in gaseous form of high pressure and high temperature into liquid of high pressure and room temperature;
a first thermal expansion valve, wherein the first thermal expansion valve is in fluid communication with the heat dissipation assembly and the cold fluid inlet, the refrigerant that is in liquid form of high pressure and room temperature expands in the first thermal expansion valve and thus is transformed into liquid-gas mixture of low pressure and low temperature, the refrigerant that is in the form of liquid-gas mixture of low pressure and low temperature absorbs a heat transferred to the heat exchanger and thus is evaporated into gas of low pressure and low temperature, thereby cooling the liquid coolant in the water-cooling system cooled by the radiator of the water-cooling system again by the refrigerant in the refrigeration system;
a second thermal expansion valve, in fluid communication with the heat dissipation assembly and wherein the refrigerant that is in liquid form of high pressure and room temperature expands in the second thermal expansion valve and thus is transformed into liquid-gas mixture of low pressure and low temperature; and
an air-cooling unit, in fluid communication with the second thermal expansion valve, wherein the refrigerant that is in the form of liquid-gas mixture of low pressure and low temperature absorbs a heat transferred to the air-cooling unit and thus is evaporated into gas of low pressure and low temperature, thereby cooling the another component to be cooled.
